(19) United States
(12) Patent Application Publication
(10) Pub. No.: US 2016/0321615 A1
(43) Pub. Date: Nov. 3, 2016

(54) INFERENCES AND ACTIONS BASED ON ACTIONS TO ADD WORKER TO JOB WAITING LISTS

(71) Applicant: SHIFTGIG, INC., Chicago, IL (US)

(72) Inventors: Michael Yoch, Chicago, IL (US); Brian Eagan, Oak Park, IL (US); Sean Patrick Casey, Chicago, IL (US)

(21) Appl. No.: 15/143,320

(22) Filed: Apr. 29, 2016

Related U.S. Application Data
(60) Provisional application No. 62/155,359, filed on Apr. 30, 2015.

(51) Int. Cl. G06Q 10/10

(52) U.S. Cl. CPC G06Q 10/1053

(57) ABSTRACT

A facility for managing an employment opportunity is described. The facility accesses information about an employment opportunity that indicates a maximum number of workers for the employment opportunity. The facility determines that a number of workers equal to the maximum number of workers have claimed the employment opportunity. In response to this determining, the facility causes to be presented to a selected worker an indication that the selected worker may join a waiting list for the employment opportunity. The facility receives input indicating that the selected worker wishes to join the waiting list for the employment opportunity. In response to receiving the input, the facility causes the selected worker to be added to the waiting list for the employment opportunity.

### CROSS-REFERENCE TO RELATED APPLICATION(S)

This application claims the benefit of U.S. Provisional Patent Application No. 62/155,359 filed on Apr. 30, 2015, which is hereby incorporated by reference in its entirety.

### TECHNICAL FIELD

The described technology is directed to technology for facilitating engagement of workers.

### BACKGROUND

A variety of conventional employment systems allow workers to learn about and sign up for jobs of various types using computers and/or smartphones.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing steps typically performed by the facility in order to permit workers to join waiting lists for engagements.

FIG. 3 is a display diagram showing a display indicating, for a particular date, the engagements that the worker has claimed or can claim.

FIG. 4 is a display diagram showing engagements for Tuesday, April 14.

FIG. 5 is a display diagram showing additional detail about the Server engagement, including date, time, duration, distance, pay rate, meeting location, on-site contact, responsibilities, uniform, venue address, etc.

FIG. 6 is a display diagram showing a display presented by the facility when the worker selects the control to add him or herself to the waiting list for the Server engagement.

FIG. 7 is a display diagram showing a display presented by the facility in which the Server engagement is moved from the “Available for waiting list” category to the “On waiting list” category.

FIG. 8 is a display diagram showing a sample display presented by the facility to notify the worker that a waitlisted engagement has become available to the worker.

FIG. 9 is a display diagram showing a sample display presented by the facility when the worker elects to claim an engagement that the worker is offered from the waiting list.

FIG. 10 is a display diagram showing the worker's list of different categories of engagements for Tuesday, Apr. 14, 2015, after claiming the Server engagement.

FIG. 11 is a display diagram showing a sample display presented by the facility when the worker fails to claim the Server engagement after a waiting list invitation is issued to the worker.

FIG. 12 is a display diagram showing a sample administrative worker interface presented by the facility to an administrative worker to reflect the status of the waiting list for a particular engagement.

FIG. 13 is a flow diagram showing steps to be performed by the facility in order to determine whether to offer the employer for an engagement an opportunity to expand the number of workers it has requested for the engagement based upon a substantial number of waitlisted workers.

### DETAILED DESCRIPTION

The inventors have recognized disadvantages of conventional employment systems, particularly those used to engage hospitality workers such as servers, hostesses, bartenders, cooks, bussers, and baristas, and shift workers of various other types. In particular, the inventors have observed that such shift workers tend to engage work assignments in irregular and dynamic ways. For example, many shift workers seek work assignments a short time before they occur, such as a matter of days, or even hours, before they occur. It is also common for workers to engage for a particular work assignment, but then be unable to fulfill it, based on illness, conflicts with other employment, school, or activities of various other types, transportation difficulties, etc. The scheduling dynamism of this type of worker can make it challenging to ensure that assignments are filled at the time they are to be worked.

The inventors have further recognized that conventional employment systems can be so full of listed assignments and/or so poorly organized that it can be difficult for many willing workers to find assignments that are suited to them.

The inventors have also recognized that conventional employment systems fail to provide feedback to the employer about the availability and interest of a larger-than-requested number of workers in a particular work assignment, which they have identified as being of significant potential value to employers.

In order to address the above-described disadvantages of conventional employment systems, the inventors have conceived and reduced to practice a software and/or hardware facility (“the facility”) for permitting workers to join a waiting list for a particular work assignment after the assignment is completely subscribed—that is, the number of workers requested for the assignment by the employer have been enlisted—and making inferences and taking action based upon the joining of a waiting list by workers.

The facility allows workers using a smart phone app or web interface to sign up for an engagement—performing a particular kind of shift work at a particular event. The events are on behalf of an employer, at a particular venue, and for a particular range of time. Where such an engagement is fully subscribed—the number of workers requested by the employer have signed up to work—other workers can add themselves to a waiting list for the engagement. If any of the workers who originally signed up for the engagement drop out, the system gives one or more workers on the waiting list the option of signing up for the engagement. If the employer expands the requested number of workers, the system does likewise.

In some embodiments, where an engagement is fully subscribed and the waiting list for the engagement includes other workers interested in working as part of the engagement, the facility notifies the employer of the availability of additional workers, and provides the employer the option of expanding the engagement by increasing the number of workers requested by the employer.

In some embodiments, the facility also interprets joining an engagement's waiting list by a worker as an expression of affinity for other engagements that are similar in some way to this engagement, such as being at roughly the same time, being in roughly the same location, being on behalf of the same employer, being of the same event type, having similar dress requirements, etc. Based upon a single such expression of affinity, and/or based upon a model generated on the basis of multiple such expressions of affinity, the system recommends other engagements to the worker that are likely to be consistent with the affinities that underlie the addition(s) to the waiting list.

By performing in some or all of the ways described above, the facility tends to do a better job of adapting to dynamic labor markets such as those for shift workers. Also, the facility in many cases conserves computing resources such as processor cycles and network capacity by obviating a former need for a worker to continue checking back about a fully subscribed engagement to see if it has become available to sign up for.

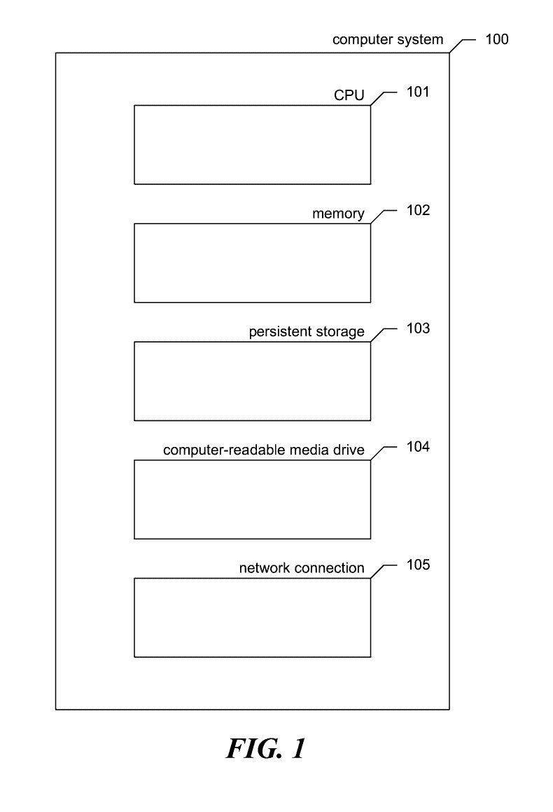

FIG. 1 is a block diagram showing some of the components typically incorporated in at least some of the computer systems and other devices on which the facility operates. In various embodiments, these computer systems and other devices 100 can include server computer systems, desktop computer systems, laptop computer systems, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware. While computer systems configured as described above are typically used to support the operation of the facility, those skilled in the art will appreciate that the facility may be implemented using devices of various types and configurations, and having various components.

In some embodiments, one or more server computer systems maintain a central state for the facility that includes information about each engagement that is available to claim and its waiting list, including descriptive information about the engagement; the number workers requested; the count and identities of workers who have claimed the engagement; the count and identities of workers who have joined the waiting list for the engagement; contact information for the employer regarding the engagement; etc. Both workers and employer representatives can access and, to certain degrees, modify this information by interacting with the server via the web, via a smartphone app, or via another modality, such as telephone. These workers and employer representatives connect to the server using a variety of mechanisms, such as the Internet, a cellular data network, a voice telephone network, etc. Each of the devices used can contain the components discussed above in connection with FIG. 1, among others.

While various embodiments are described in terms of the environment described above, those skilled in the art will appreciate that the facility may be implemented in a variety of other environments including a single, monolithic computer system, as well as various other combinations of computer systems or similar devices connected in various ways.

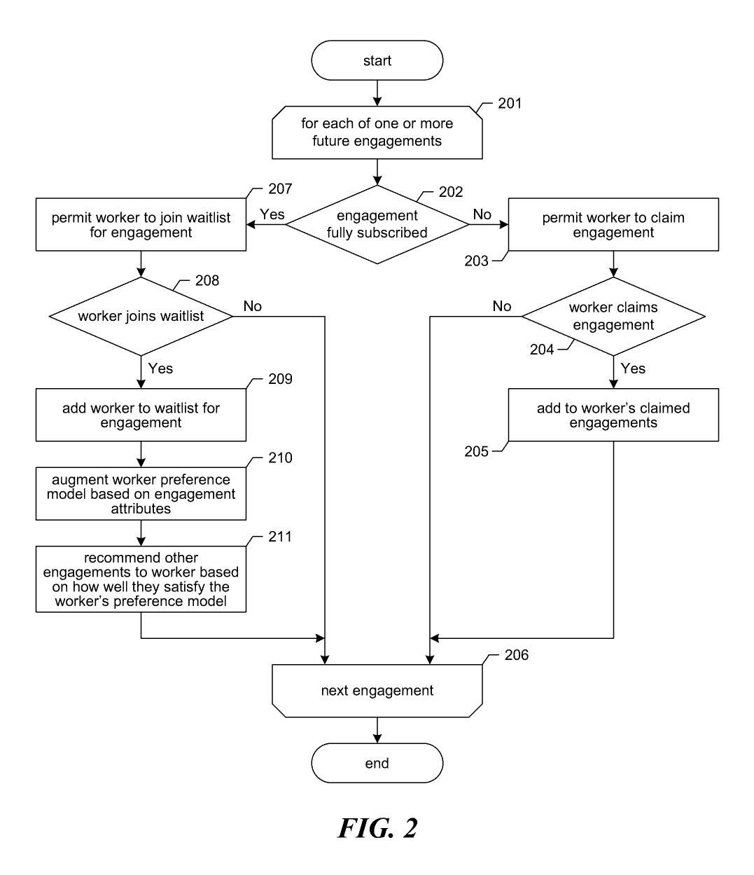

FIG. 2 is a flow diagram showing steps typically performed by the facility in order to permit workers to join waiting lists for engagements. The facility loops through steps 201-206 for each of one or more engagements that will occur in the future, such as engagements that match a worker's search query, engagements in a particular engagement category selected by the worker, or engagements that are otherwise likely to be relevant to the worker. In some embodiments, the facility omits to select future engagements that it expects to be inconsistent with the worker's schedule, such as engagements whose time period intersects with other engagements already accepted by the worker; engagements whose time periods intersect with a time period that the worker has previously indicated they are unavailable; engagements whose location is too great a distance from the location of another engagement the worker has accepted, or another location that the worker is otherwise expected to be; etc.

In step 202, if the current engagement is fully subscribed—that is, if the maximum number of workers specified by the employer have claimed the engagement, then the facility continues in step 207, else the facility continues in step 203. In step 203, the facility permits the worker to claim the engagement and commit him or herself to work in the engagement. In step 204, if the worker claims the engagement, then the facility continues in step 205, else the facility continues in step 206. In step 205, the facility adds the engagement to the worker's claimed engagements. In step 206, the facility continues to process the next engagement. After step 206, these steps conclude.

Where the engagement is fully subscribed, the facility continues from step 202 to step 207. In step 207, the facility permits the worker to join the waiting list for the engagement. In step 208, if the work joins the waiting list for the engagement, then the facility continues in step 209, else the facility continues in step 206. In step 209, the facility adds the worker to the waiting list for the engagement. In step 210, the facility augments a worker preference model that reflects the attributes of an engagement that the facility has inferred attract this worker to engagements. For example, in various embodiments, the worker preference model covers such attributes—and combinations thereof—as position type, location, time of day, day of week, duration, pay rate, responsibilities, dress code, worker equipment required, etc. Over time, the facility progressively refines the worker's preference model based upon the expanding list of waiting lists for engagements that the worker has joined. In some embodiments, the facility also augments the worker preference model based upon attributes of engagements that the worker claims in steps 203-204 (not shown). By augmenting the worker preference model based upon waiting list-joining actions, instead of or in addition to engagement claiming actions, the facility can more quickly accumulate observations about the worker and the worker's preferences, and more quickly construct a useful work or preference model for the worker.

In some embodiments (not shown), the facility uses aggregations of a worker's engagement claiming and waiting listing behavior as a measure of the worker's engagement with the facility, and may treat highly-engaged workers differently, such as by recommending additional engagements to them, increasing their ability to accept engagements or receive waiting list invitations for them, etc.

In step 211, the facility recommends other future engagements to the worker based upon how well they satisfy the preference model established and refined for the worker by the facility. After step 211, the facility continues in step 206.

Those skilled in the art will appreciate that the steps shown in FIG. 2 and in each of the flow diagrams discussed below may be altered in a variety of ways. For example, the order of the steps may be rearranged; some steps may be performed in parallel; shown steps may be omitted, or other steps may be included; a shown step may divided into substeps, or multiple shown steps may be combined into a single step, etc.

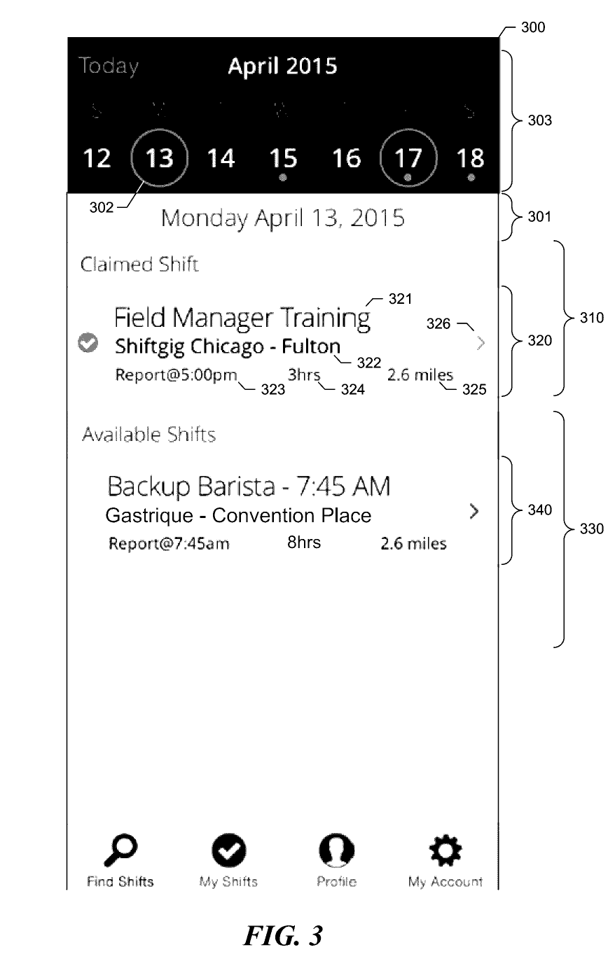

FIGS. 3-11 are display diagrams showing displays of a visually worker interface used by the facility in some embodiments, such as a visually worker interface of a smartphone app that makes up part of the facility. In particular, the smartphone app is installed on a smartphone belonging to a particular worker, and the app provides information on engagements at which the worker may wish to work, and permits the worker to claim such engagements, and/or add himself or herself to the waiting list for such engagement.

FIG. 3 is a display diagram showing a display indicating, for a particular date, the engagements that the worker has claimed or can claim. It can be seen from the portion 301 of the display 300 that the date currently being displayed is Monday, Apr. 13, 2015. In addition, the day for which shifts are being displayed is also shown by grey-filled circle 302 in calendar 303. The Claimed Shift section 310 shows that the worker has claimed an engagement 320 on this date for the position “Field Manager Training” 321 at the venue “Shiftgig Chicago—Fulton” 322. This engagement is three hours long 324, 2.6 miles 325 away from the worker's present location, the worker's home, or another location associated with the worker, and the worker is to report for work at 5 p.m. 323 on Monday, Apr. 13, 2015. In the Available Shifts section 330, display also indicates that another engagement 340 is available for the worker to claim to work on Monday, Apr. 13, 2015—the position is “Backup Barista,” at a “Gastrique—Convention Place” venue. The worker can select the Field Manager Training, such as by touching its portion of the screen or control 326, to see additional information about this engagement, withdraw the worker's claim for this engagement, etc. The worker can similarly select the Backup Barista engagement in order to claim that engagement.

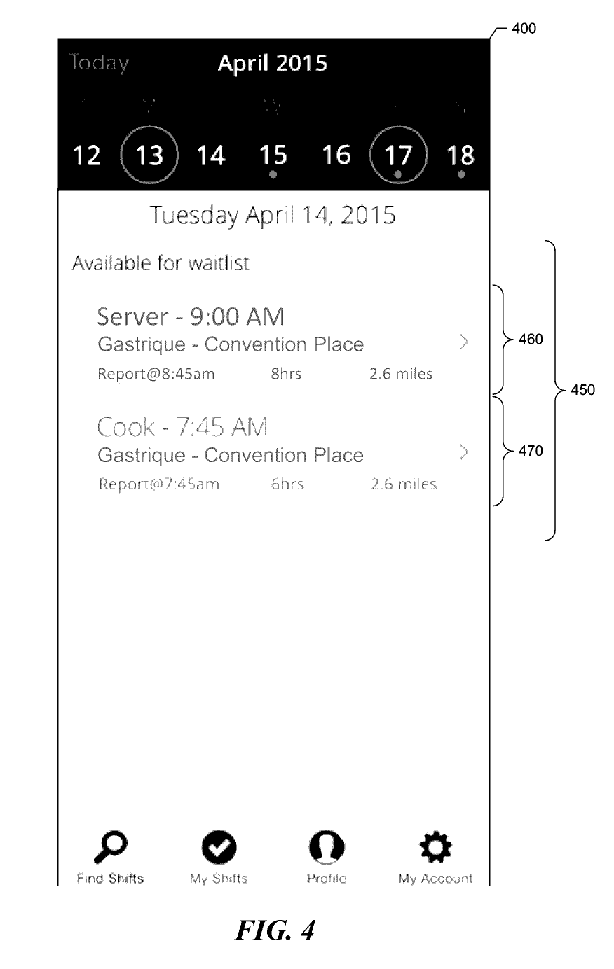

FIG. 4 is a display diagram showing engagements for Tuesday, April 14. The worker has not claimed any engagements on this day, and no engagements are available to claim. However, the Available for waitlist section 450 indicates that the worker is able to join the waiting list for two fully-subscribed engagements shown in FIG. 4: a Server engagement 460 and a Cook engagement 470. The worker can select the Server engagement, for example, in order display additional details about this engagement.

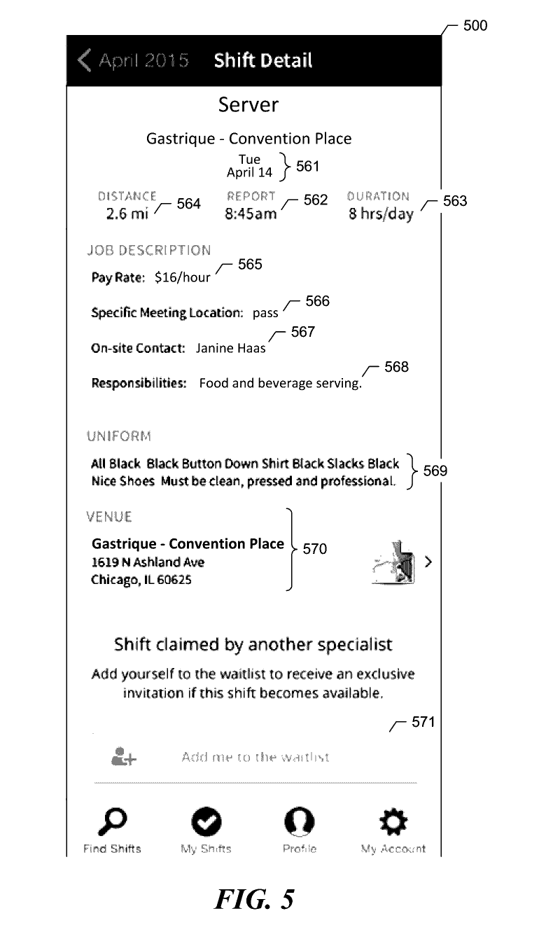

FIG. 5 is a display diagram showing additional detail about the Server engagement. The display 500, displayed such as in response to selection of the server engagement 460 in display 400, includes information about the engagement such as date 561, time 562, duration 563, distance 564, pay rate 565, meeting location 566, on-site contact 567, responsibilities 568, uniform 569, venue address 570, etc. The display also contains a control, such as a button 571, that the worker can select in order to add himself or herself to the waiting list for this engagement.

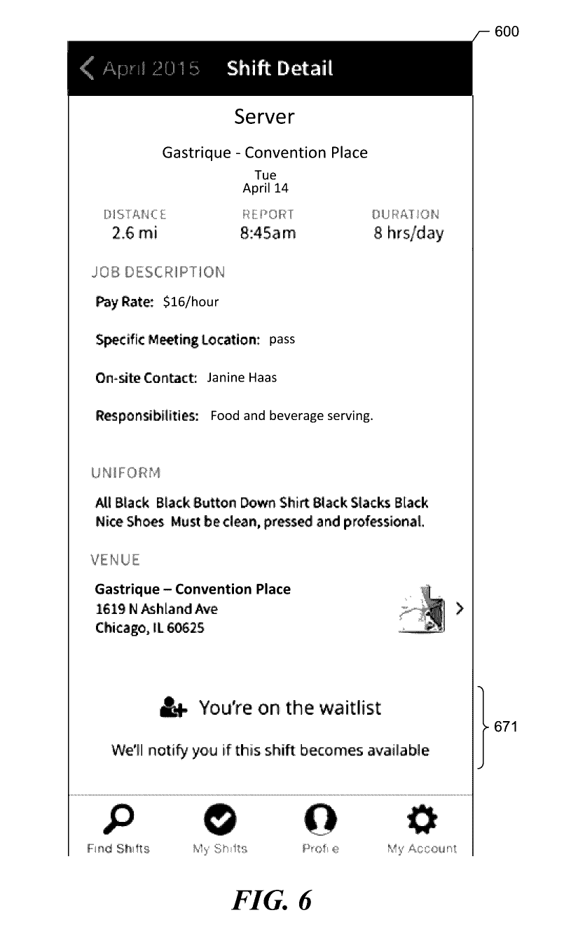

FIG. 6 is a display diagram showing a display presented by the facility when the worker selects the control to add himself or herself to the waiting list for the Server engagement. The display 600 includes a textual message 671 indicating that the worker has joined the waiting list. In some embodiments, this is reflected in the change to the display diagram shown in FIG. 4, in which the Server engagement is moved from the “Available for waiting list” category to an “On waitlist” category.

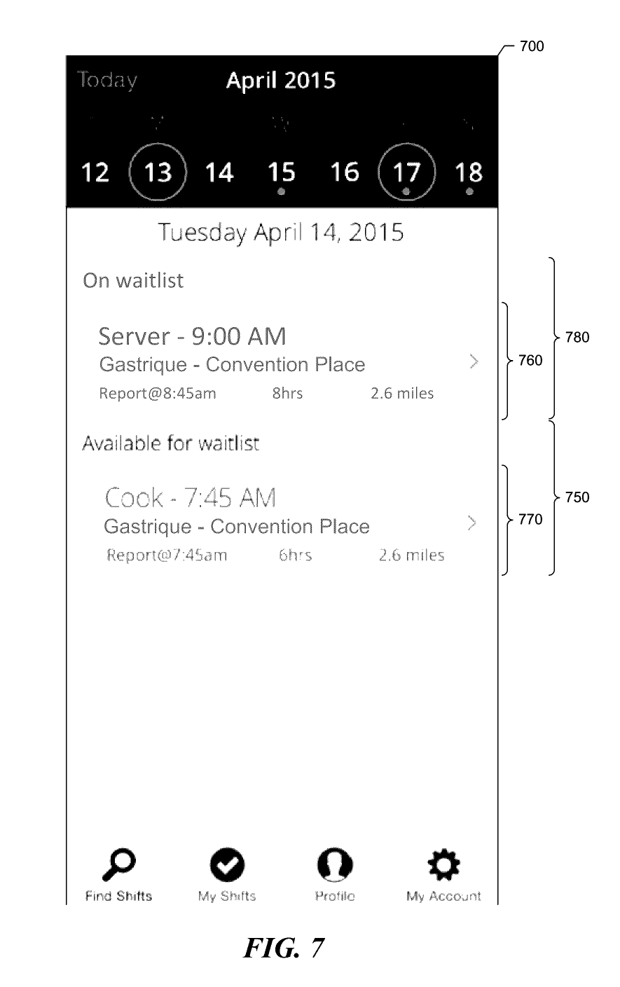

FIG. 7 is a display diagram showing a display presented by the facility in which the Server engagement is moved from the “Available for waitlist” category to an “On waitlist” category. The display 700 shows that the Server engagement 760 has been moved from the Available for waitlist section 750 to the On waitlist section 780.

If, at a time before the engagement begins, additional positions become available for the Server engagement—such as because the employer expands the number of workers requested, or because workers who have claimed the engagement relinquish their claim—then the facility notifies a worker on the waiting list for the engagement that he or she is able to claim the engagement, such as by sending a text, sending an email, making an automated call to the worker, making a human call to the worker, and/or presenting a message within the app.

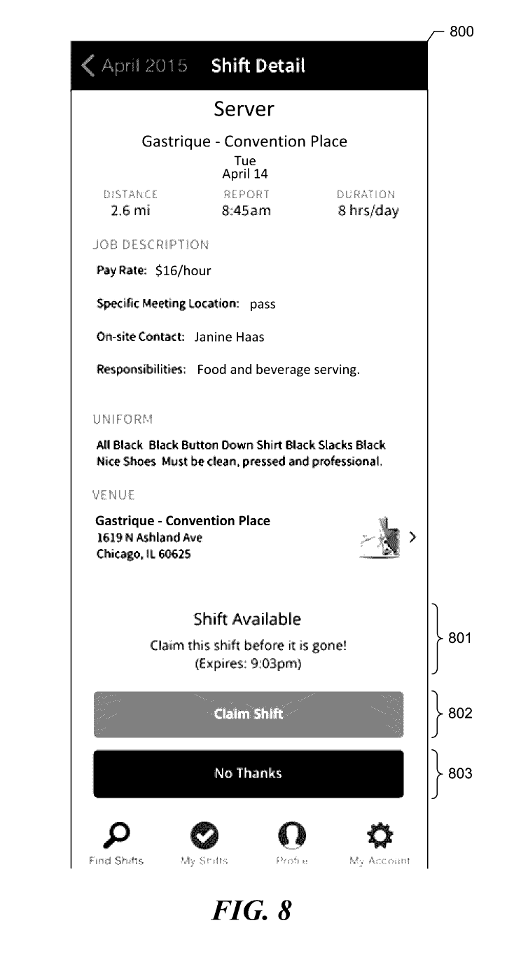

FIG. 8 is a display diagram showing a sample display presented by the facility to notify the worker that a waitlisted engagement has become available to the worker. In various embodiments, the worker has various periods of time in which the worker can claim an engagement once the worker has been selected from the waiting list, such as two hours. The worker can claim that engagement, can explicitly decline the engagement, or can allow their invitation to the claim to expire. The display 800 shows a textual message 801 indicating that the waitlisted engagement shown on the display has been made available to the worker. It further includes a control 802 that the user can activate in order to claim the shift, and a control 803 that the user can activate in order to decline the shift. If the user claims the shift, it is added to their Claimed shift section 310 shown in FIG. 3; otherwise, the facility selects another user from the waiting list and offers the engagement to this other user.

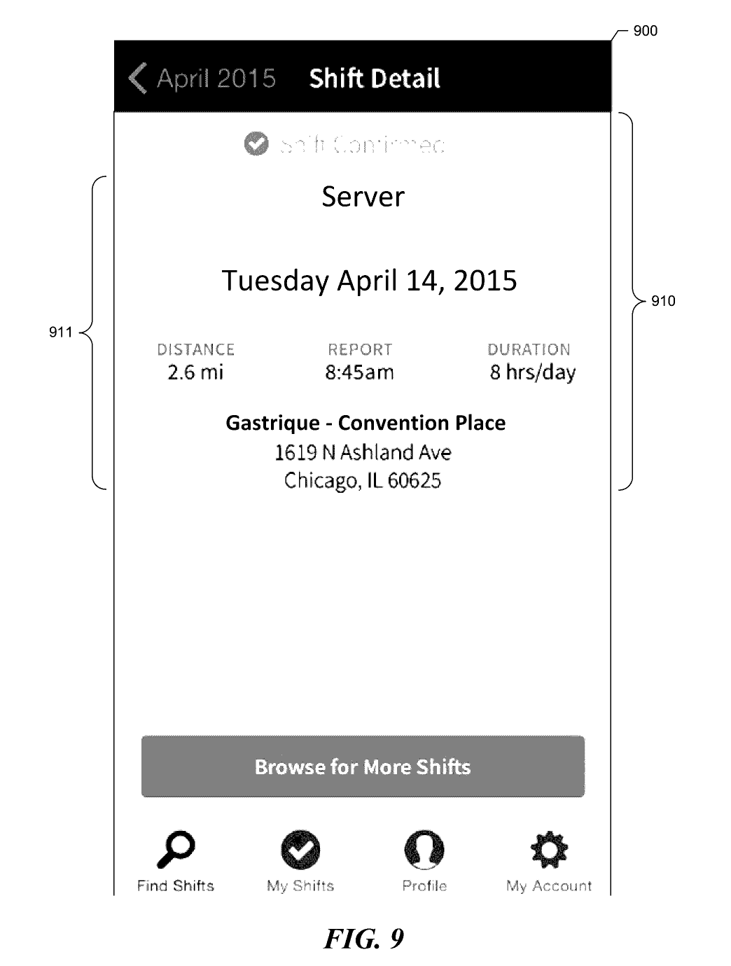

FIG. 9 is a display diagram showing a sample display presented by the facility when the worker elects to claim an engagement that the worker is offered from the waiting list. The display 900 shows a confirmation message 910 indicating that the worker's claim of the engagement is confirmed, and contains the information 911 needed by the worker in order work at the engagement.

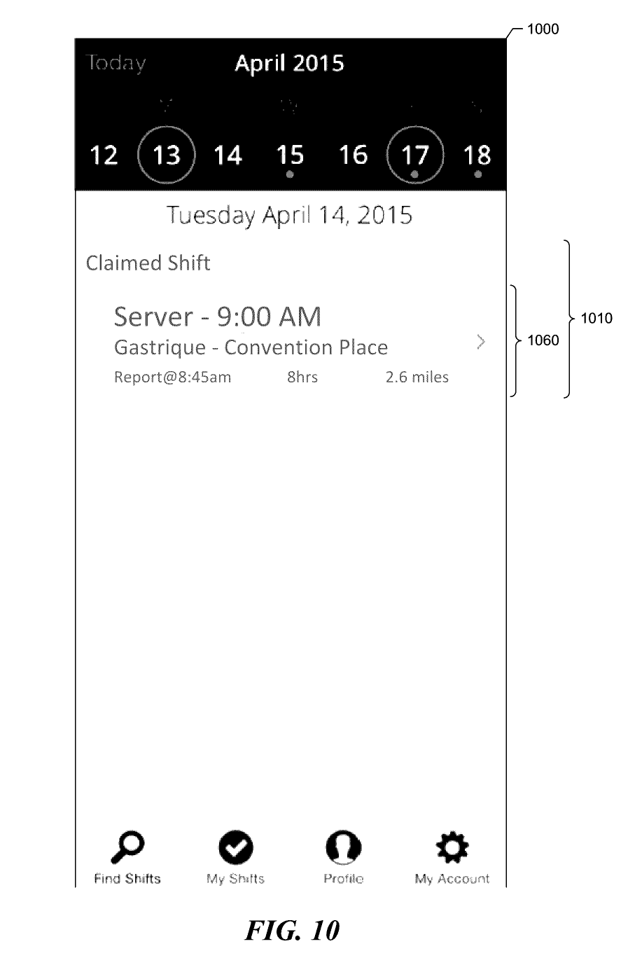

FIG. 10 is a display diagram showing the worker's list of different categories of engagements for Tuesday, Apr. 14, 2015, after claiming the Server engagement. The display 1000 contains the Server engagement 1060 in its Claimed shift section 1010, indicating that the worker has claimed the Server engagement.

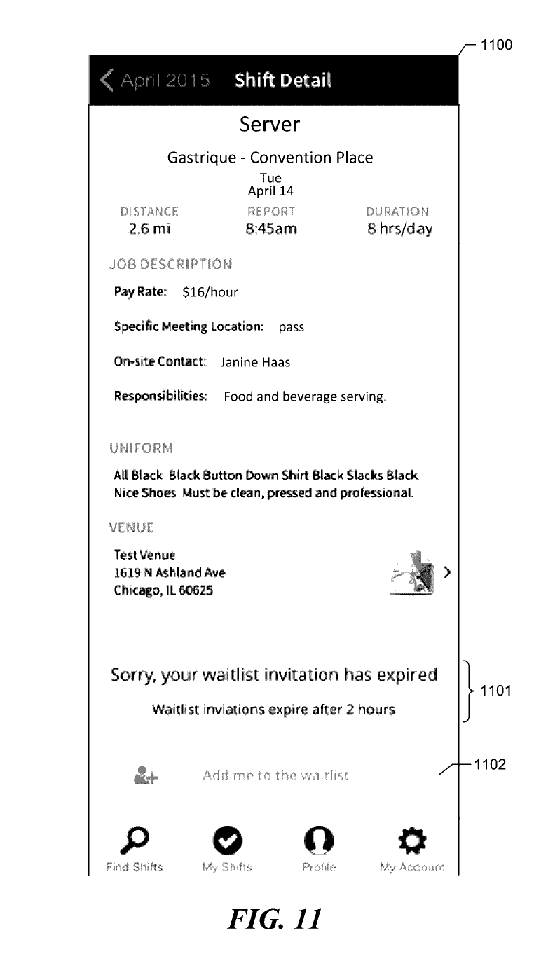

FIG. 11 is a display diagram showing a sample display presented by the facility when the worker fails to claim the Server engagement during the designated period after a waiting list invitation is issued to the worker. It can be seen that the display 1100 includes an indication 1101 that the waiting list invitation has expired, and a control 1102 that the worker can activate in order to return to the waiting list for this engagement.

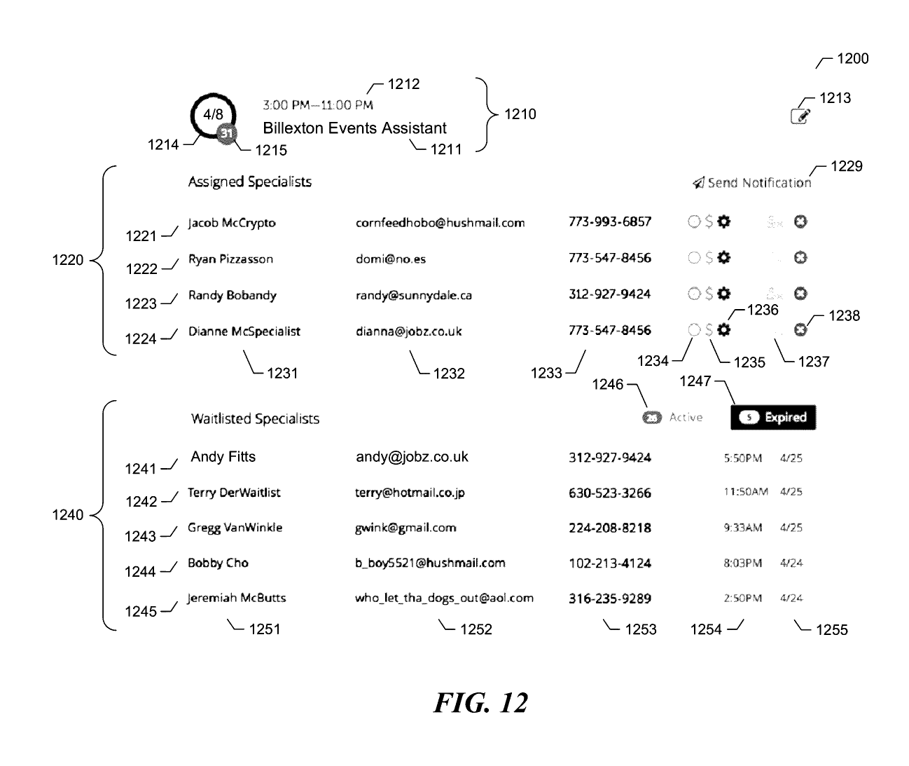

FIG. 12 is a display diagram showing a sample display that is part of administrative worker interface presented by the facility in some embodiments to an administrative worker to reflect the status of the waiting list for a particular engagement. The display 1200 includes a title section 1210 that identifies a particular engagement, containing information such as the position 1211 and its duration 1212. The user can activate control 1213 in order to edit the information about the engagement. The title section further contains an indication 1214 that four of eight available spots are occupied by workers who have claimed this “Billexton Events Assistant” engagement, and an indication 1215 that there are 31 people on the wait list for this engagement. The display further includes an Assigned Specialists section 1220 that includes a list of workers 1221-1224 that have claimed the engagement. For each of these workers, the facility shows the following information: name 1231, email address 1232, telephone number 1233, an indication 1234 that hours have been entered for the worker for the shift, an indication 1235 that compensation for the worker in this engagement has been altered from the group compensation for the engagement, a control 1236 initiate editing compensation for this worker for the engagement, a control 1237 to remove this worker from the engagement without reducing the maximum number of workers for the engagement, and a delete control 1238 that the user can activate to delete the worker from the list of workers assigned to the engagement and reduce the maximum number of workers for the engagement by 1, such as from 8 to 7 as shown. This section also includes a control 1229 to send a notification to all of the assigned workers, such as a notification requesting a particular mode of dress, one letting the workers know of a particular condition at the engagement, etc. The display also includes a Waitlisted Specialists section 1240 identifying workers on the waiting list for this engagement. As shown, the waitlisted workers are divided into those who are actively on the waiting list, and those that have been given invitations that have expired. The dark rectangle around expired indication 1247 indicates that the workers 1241-1245 displayed in this section are those whose invitations to leave the waiting list and claim the engagement have expired. The expired indication 1247 includes a count of “5.” Indication 1246 shows that there are 26 workers that are active members of the waiting list. To display a list of these 26 active members of the waiting list, the user can activate indication 1246. It can be seen that, for each of the shown workers whose invitation has expired, the display includes: the worker's name 1251, email address 1252, telephone number 1253, and the date 1255 and time 1254 at which their invitation expired. The facility proceeds through the active waitlisted workers, sending them waiting list invitations to claim the engagement, and proceeding to additional waitlisted workers if they do not.

In some embodiments, the facility notifies the employer where a waiting list contains more workers than are expected to be needed to fill the requested number of positions, to allow the employer an opportunity to expand the number of positions with a reasonably likelihood that the expanded number of positions will be filled. In various embodiments, this notification of the employer is fully automatic, while in some embodiments it involves manual steps. In various embodiments, the facility uses various techniques to contact the employer, such as by sending email, a text message, an automated call, a human call, or sending a notification to a version of the facility's smartphone app for employers.

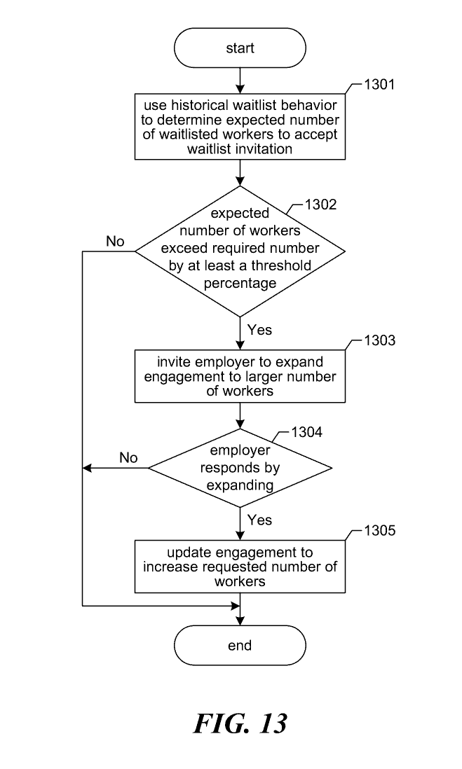

FIG. 13 is a flow diagram showing steps to be performed by the facility in order to determine whether to offer the employer for an engagement an opportunity to expand the number of workers it has requested for the engagement based upon a substantial number of waitlisted workers. In some embodiments, the facility performs these steps periodically for each fully-subscribed engagement having at least one person on the waiting list, such as once per hour, once every five minutes, etc.

In step 1301, for a particular engagement that is fully subscribed and has workers on its waiting list, the facility uses historical waiting list behavior to determine an expected number of the waitlisted workers that will accept the waiting list invitation. In various embodiments, the facility uses a percentage of acceptances across the facility; a percentage of acceptances among waiting lists that are similar in some way to this one, such as those that are from the same type of position, or those that are at a similar combination of day of the week and time of day; acceptance percentages for the particular workers on this waiting list; etc. In step 1302, if the expected number of workers determined in step 1301 exceeds the number of workers presently requested by the employer for this engagement by at least a threshold percentage—such as 10% or 25%, then the facility continues in step 1303, else these steps conclude. In step 1303, the facility invites the employer to expand the engagement to a larger number or workers. In step 1304, if the employer responds to the invitation by expanding the number of workers requested, then the facility continues in step 1305, else these steps conclude. In step 1305, the facility updates the engagement to increase the requested number of workers. This, in turn, causes the facility to make waiting list invitations to a larger number of workers on the waiting list, and may result in the engagement eventually returning to a state where it is not fully subscribed, and workers can directly claim the engagement. After step 1305, these steps conclude.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A method in a computer system for managing an employment opportunity, the method comprising:
accessing information about an employment opportunity that indicates a maximum number of workers for the employment opportunity;
determining that a number of workers equal to the maximum number of workers have claimed the employment opportunity;
in response to the determining, causing to be presented to a selected worker an indication that the selected worker may join a waiting list for the employment opportunity;
receiving input indicating that the selected worker wishes to join the waiting list for the employment opportunity; and
in response to receiving the input, causing the selected worker to be added to the waiting list for the employment opportunity.

2. The method of claim 1 wherein the indication is presented to the selected worker in response to the selected worker reviewing information about the employment opportunity.

3. The method of claim 1 wherein the indication is presented to the selected worker at a time when the selected worker is not reviewing information about the employment opportunity.

4. The method of claim 1 wherein the indication is presented to the selected worker in response to matching a worker preference model for the selected user with attributes of the employment opportunity.

5. The method of claim 1, further comprising:
determining that the maximum number of workers exceeds the number of workers who have claimed the employment opportunity;
in response to determining that the maximum number of workers exceeds the number of workers who have claimed the employment opportunity, causing to be presented to the selected worker an invitation to claim the employment opportunity;
receiving input indicating that the selected worker wishes to claim the employment opportunity; and
in response to receiving input indicating that the selected worker wishes to claim the employment opportunity, claiming the employment opportunity on behalf of the worker.

6. The method of claim 1, further comprising:
determining that the maximum number of workers exceeds the number of workers who have claimed the employment opportunity;
in response to determining that the maximum number of workers exceeds the number of workers who have claimed the employment opportunity, causing to be presented to the selected worker an invitation to claim the employment opportunity, the presented imitation including an explicitly-indicated expiration time.

7. The method of claim 6 wherein determining that the maximum number of workers exceeds the number of workers who have claimed the employment opportunity comprises determining that a worker who claimed the employment opportunity subsequently declined the employment opportunity.

8. The method of claim 6 wherein determining that the maximum number of workers exceeds the number of workers who have claimed the employment opportunity comprises determining that an employer associated with the employment opportunity has increased the maximum number of workers for the employment opportunity.

9. The method of claim 1, further comprising:
in response to the input, augmenting a worker preference model for the selected worker using information about the employment opportunity; and
recommending one or more additional employment opportunities to the selected worker based upon how well the additional employment opportunities satisfy the worker's augmented preference model.

10. The method of claim 9, further comprising:
accessing information about a second employment opportunity that indicates a maximum number of workers for the second employment opportunity;
determining that a number of workers less than the maximum number of workers have claimed the second employment opportunity;
in response to determining that a number of workers less than the maximum number of workers have claimed the second employment opportunity, causing to be presented to the selected worker an indication that the selected worker may claim the second employment opportunity;
receiving second input indicating that the selected worker wishes to claim the second employment opportunity;
in response to receiving the second input:
claiming the second the employment opportunity for the selected worker; and
augmenting the worker preference model for the selected worker using information about the second employment opportunity.

11. The method of claim 1, further comprising;
determining a number of workers on the waiting list for the employment opportunity;
using historical waitlist behavior, determining an expected number of the workers on the waitlist to accept a waitlist invitation, if issued; and
if the expected number exceeds the required number of workers for the employment opportunity to at least a threshold extent, causing to be presented to a worker associated with the employer an invitation to increase the maximum number of workers for the employment opportunity.

12. A computer-readable medium having contents configured to cause a computing system to, in order to manage an employment opportunity:
access information about an employment opportunity that indicates a maximum number of workers for the employment opportunity;
determine that a number of workers equal to the maximum number of workers have claimed the employment opportunity;
in response to the determining, cause to be presented to a selected worker an indication that the selected worker may join a waiting list for the employment opportunity;
receive input indicating that the selected worker wishes to join the waiting list for the employment opportunity; and
in response to receiving the input, cause the selected worker to be added to the waiting list for the employment opportunity.

13. A computer-readable medium having contents configured to cause a computing system to:
operate a platform that enables workers among the plurality of workers to perform interactions of one or more types with employment opportunities among a body of employment opportunities;
for each interaction performed, store an indication of the interaction in connection with the worker performing it;
for at least a portion of the plurality of workers, determine an engagement score that is based upon the type, volume, or frequency of the interactions indicated by the indications stored in connection with the worker; and
for each worker for whom an engagement score is determined that exceeds a threshold engagement score, allocate to the worker a privilege for using the platform not allocated to workers for home engagement score is not determined that exceeds the threshold engagement score.

14. The computer-readable medium of claim 13 wherein the allocated privilege is recommending employment opportunities to workers to whom the privilege is allocated.

15. The computer-readable medium of claim 13 wherein the allocated privilege is permitting workers to whom the privilege is allocated to claim employment opportunities at an earlier time than workers to whom the privilege is not allocated.

16. The computer-readable medium of claim 13 wherein the allocated privilege is permitting workers to whom the privilege is allocated to join a waitlist for an employment opportunity at time when workers to whom the privilege is not allocated is not permitted to join the waitlist.

17. The computer-readable medium of claim 13 wherein the determined engagement score correlates positively with an interaction type selected from among: frequently viewing information about employment opportunities; frequently claiming employment opportunities; frequently joining waitlists for employment opportunities; having good attendance at claimed employment opportunities; having good timeliness at claimed employment opportunities; and having good evaluations at claimed employment opportunities.

18. The computer-readable medium of claim 13 wherein the determined engagement score correlates negatively with an interaction type selected from among: frequently withdrawing from claimed employment opportunity; frequently withdrawing from employment opportunity waitlists; infrequently viewing information about employment opportunities; infrequently claiming employment opportunities; infrequently joining waitlists for employment opportunities; not having good attendance at claimed employment opportunities; not having good timeliness at claimed employment opportunities; and not having good evaluations at claimed employment opportunities.

19. A computing system comprising:
a processor; and
memory having contents that, when executed by the processor:
operate a platform that enables workers among the plurality of workers to perform interactions of one or more types with employment opportunities among a body of employment opportunities;
for each interaction performed, store an indication of the interaction in connection with the worker performing it;
for at least a portion of the plurality of workers, determine an engagement score that is based upon the type, volume, or frequency of the interactions indicated by the indications stored in connection with the worker; and
for each worker for whom an engagement score is determined that exceeds a threshold engagement score, allocate to the worker a privilege for using the platform not allocated to workers for home engagement score is not determined that exceeds the threshold engagement score.
